(19) United States
(12) Patent Application Publication
(10) Pub. No.: US 2013/0327188 A1
(43) Pub. Date: Dec. 12, 2013

(54) SLIP-RESISTANT SCREWDRIVER FOR SLOTTED SCREWS AND METHOD FOR DRIVING SLOTTED SCREWS

(71) Applicant: Roger F. Wilson, Sarasota, FL (US)

(72) Inventor: Roger F. Wilson, Sarasota, FL (US)

(21) Appl. No.: 13/493,250

(22) Filed: Jun. 11, 2012

(51) Int. Cl. B25B 23/08

(52) U.S. Cl. 81/441

(57) ABSTRACT

A screwdriver blade and method for driving a conventional screw having a single transverse slot is disclosed. The driver blade has an elongated body having a central longitudinal axis and a tip. The tip has a distal end in the form of a planar end face that is arranged to engage the bottom surface of the screw's slot. The end face includes a sharply tapered symmetrical spike projecting outward from it along an axis parallel to the central longitudinal axis of the blade. The spike is arranged to dig into the material of the screw at the bottom surface of the screw's slot to prevent slippage of the tip within the slot and without marring the appearance of the slot.

### FIELD OF THE INVENTION

This invention relates generally to tools and more particularly to slip-resistant screwdriver blades for slotted screws and methods for driving such screws.

### BACKGROUND OF THE INVENTION

Many well established types of screwdriver styles are on the market for securely positioning the driver's tip within the mating geometry in the screw head. Examples of such styles are Phillips, hex-head, and Torx®, to name only a few. The advantages of this positional stability cannot be overstated in assisting with the ease and efficiency of driving screws. Unfortunately slotted screws do not enjoy this stability and for many reasons remain quite popular, but historically continue in need of a viable solution to ending the frustrations that come with the difficulty of keeping the screw driver blade properly positioned and engaged with the slot. Previous attempts to mitigate this problem have all proven minimally effective in function and or burdened by excessive complexity and cost. For example, external guides are encumbered by fit limitations, complexity, and cost. Other more exotic methods to help reduce slippage by utilizing diamond or tungsten carbide coatings have offered minimal improvement and are anything but inexpensive to produce.

The advent and popularity of electrical means to drive screws has, before now, been of little to no help or benefit since the increase in inertia from rotational speed actually did exacerbate the usual difficulties associated with driving slotted screws.

The patent literature includes various examples of screwdrivers for slotted head screws, wherein the screwdriver includes features at its tip to prevent slippage of the tip in the screw head slot and, in some cases, the screw is non-conventional, i.e., includes features, e.g., keying features, which are specially designed to cooperate with the special feature(s) of the screwdriver blade. See for example, U.S. Pat. No. 1,899,489 Wickbergh); U.S. Pat. No. 4,339,971 (Zatorre); U.S. Pat. No. 5,259,279 (Strauch); U.S. Pat. No. 5,347,893 (Mikic et al.); U.S. Pat. No. 6,216,569 (Hu) and U.S. Pat. No. 6,378,406 (Totsu); and United States Published Applications: US2008/0022816 (Feldman); US 2009/0165604 (Macor); and 2010/0288086 (Huang).

Notwithstanding the above, a need exists for slotted head screwdriver which is effective to prevent slippage of the screwdriver's tip within a conventional slotted screw (i.e., a screw having a single transversely extending slot which is not undercut and which includes a planar bottom surface) that is simple in construction, low in cost and easy to use and does not mar the appearance of the screw. The subject invention addresses those needs.

### SUMMARY OF THE INVENTION

In accordance with one aspect of this invention there is provided a driver blade for driving a conventional slotted screw. The slotted screw comprises a head having a single transversely extending slot with a planar bottom surface. The driver blade comprises an elongated body having a central longitudinal axis and a tip. The tip has a distal end in the form of a planar end face, which is arranged to engage the planar bottom surface of the screw slot. The tip also includes a sharply symmetrically tapered, e.g., a conical or pyramidal shaped, spike projecting outward from the planar end face along an axis parallel to the central longitudinal axis. The spike is arranged to dig into or penetrate the material of the screw at the planar bottom surface of the screw's slot while the screw is being driven to prevent slippage of the tip in the slot, whereupon after driving of the screw only a single small depression remains in the bottom of the screw's slot, thereby not marring the appearance of said slot.

In accordance with one exemplary embodiment of this invention the tip includes a single spike, which is located on the central longitudinal axis of the blade. In accordance with another exemplary embodiment of this invention the tip includes three spikes, one of which is located on the central longitudinal axis and the other two spikes equidistantly spaced from the spike on the central longitudinal axis. In the three-spike embodiment driving of the screw leaves only three small depressions in the bottom of the screw's slot, thereby not marring the appearance of the slot.

In accordance with still another exemplary embodiment of this invention the spike(s) can be formed of a material that is different and harder than the material making up the blade, depending upon the hardness of the head of the screw.

In accordance with another aspect of this invention, a method of driving a conventional slotted screw is provided. The slotted screw includes a head having a single transversely extending slot. The slot is not undercut and includes a bottom surface, which is planar. The method entails providing a screwdriver blade comprising an elongated body having a central longitudinal axis and a tip. The tip has a distal end in the form of a planar end face, which is arranged to engage the planar bottom surface of the screw slot. The tip also includes a sharply symmetrically tapered, e.g., a conical or pyramidal shaped, spike projecting outward from the planar end face along an axis parallel to the central longitudinal axis. To drive the screw the blade is inserted into the screw's slot and a force applied along the central longitudinal axis so that the spike engages and penetrates into the material of the screw at its bottom surface and the planar end face of the blade engages that bottom surface to drive the screw expeditiously to prevent slippage of the tip within the slot. Moreover, after driving of the screw only a single small depression remains in the bottom of the screw's slot, thereby not marring the appearance of the slot.

### DESCRIPTION OF THE DRAWING

FIG. 1 is an isometric view of one exemplary embodiment of a screwdriver having a non-slip blade constructed in accordance with this invention;

FIG. 2 is an enlarged isometric view of the non-slip tip portion of the screwdriver blade shown within the circle 2 of FIG. 1;

FIG. 3 is a side elevation view of one exemplary conventional slotted screw that a non-slip blade of this invention can be used to drive without slippage or without marring the appearance of the screw's slot;

FIG. 4 is an isometric view of the shank and tip of another exemplary embodiment of a screwdriver blade constructed in accordance with this invention; and

FIG. 5 is an isometric view of the tip portion of another exemplary embodiment of a screwdriver blade constructed in accordance with this invention.

### DETAILED DESCRIPTION OF THE PREFERRED EMBODIMENT

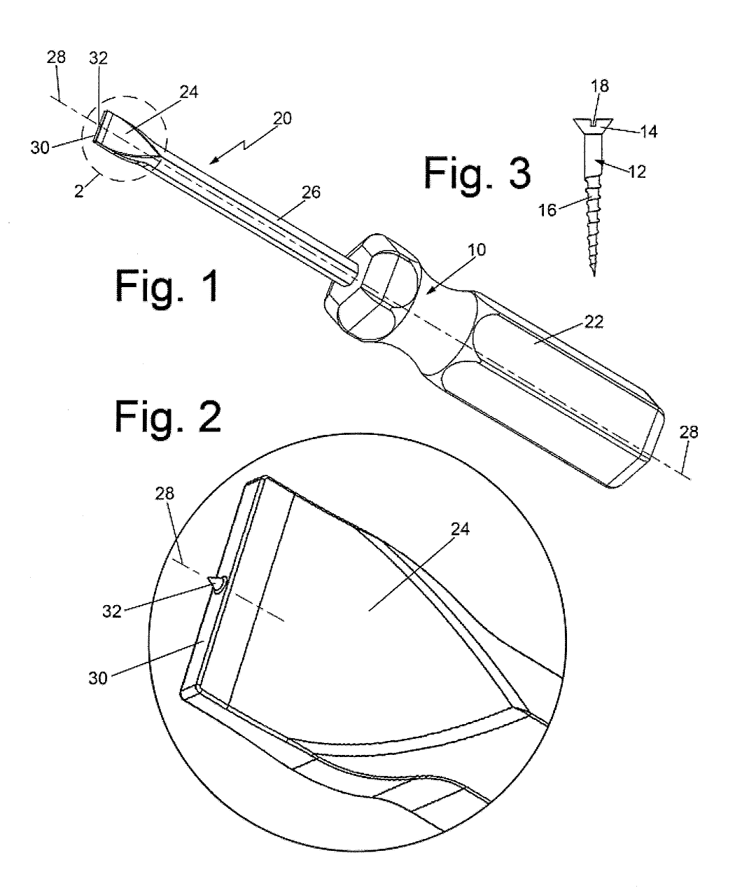

Referring now to the various figures of the drawing, wherein like reference characters refer to like parts, there is shown in FIG. 1 an exemplary embodiment of a screwdriver 10 having a non-slip blade 20 constructed in accordance with this invention. The screwdriver 10 basically comprises the blade 20 and a handle 22 to which the blade is secured. It should be pointed out at this juncture that the blade 20 is not limited to use in a screwdriver like shown in FIG. 1. Thus, non-slip blades constructed in accordance with this invention can be designed for use in a socket or chuck of a manual or electric screwdriver (not shown) and do not have to be fixedly secured to a handle.

In the exemplary embodiment shown in FIG. 1, the blade is an elongated member having a tip portion 24 and a shank portion 26. The shank portion is disposed and secured within the handle 22 so that its central longitudinal axis 28 is coaxial with the central longitudinal axis of the handle. If the blade 20 is designed for use in a socket its shank portion will be of a suitable peripheral profile to fit within the socket. If the blade is designed for use in a chuck the periphery of the shank may be circular or any other regular shape that can be accommodated by the chuck. In any case, the tip portion 24 of the blade 20 is similar to conventional flat bladed screwdriver's tip except for the inclusion of at least one spike or point feature (to be described shortly), which prevents slippage of the tip in the slot of the screw.

Before describing the tip and its non-slip spike feature of the blade of this invention a brief description of the type of conventional single slotted screws for which the blade of this invention has particular utility is in order. One such exemplary screw 12, i.e., a flat head wood screw, is shown in FIG. 3. That screw, and all other screws for which this invention has utility, includes a head 14 and a threaded shank 16. The head has a single, linear slot 18 extending transversely across it. The slot is not undercut one either of its sidewalls and includes a bottom surface which is planar and does not include any depression or other keying feature. The screw can be made of any material, e.g., steel, brass, plastic, etc.

Turning now to FIG. 2 it can be seen that the tip portion 24 of the blade 20 is in the form of a planar end face 30, which extends perpendicularly to the central longitudinal axis 28 of the blade. A small, symmetrically tapered (in this case conical) sharp spike or point 32 projects outward from the plane of the end face 30 and in the embodiment shown in FIGS. 1 and 2 is centered on the central longitudinal axis. The spike is arranged to dig in or embed itself slightly into the planar bottom surface of the screw's slot 18 when the blade is used to drive the screw. In particular, the force applied to the handle of the screwdriver 20 to drive the screw will be sufficient to cause the spike to dig in or embed itself slightly into the material making up the screw. This digging in or embedding action will be sufficient to prevent lateral slippage of the tip of the blade along the screw slot and will not materially damage the slot or otherwise detract from the slot's normal appearance, i.e., the single depression in the bottom surface of the slot produced by the spike will be very small and thus not readily noticeable to the naked eye.

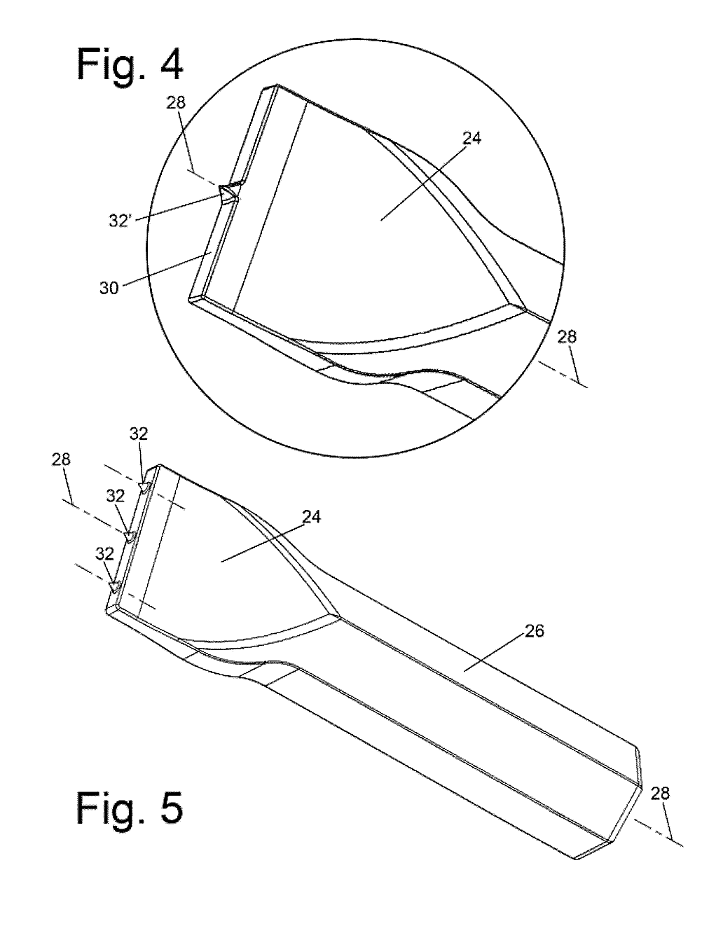

It should be noted that the particular shape of the spike is not critical to the invention, so long as the spike is symmetrical and tapers to a sharp point. Thus, in lieu of a conical spike, such as shown in FIGS. 1 and 2, the spike may be of a square or triangular pyramidal shape, like spike 32′ shown in FIG. 4. Other sharply tapered symmetrical spikes or points are also contemplated, it being understood by those skilled in the art that either of the two foregoing exemplary types of spikes 32 and 32′ or other similarly shaped spikes will maintain the essence of the invention and be more of less effective and more or less conducive to efficiency of manufacture.

The blades 20 shown in FIGS. 1 and 4 include only a single spike 32 and it is located on the central longitudinal axis 28 of the blades 20. That arrangement is not exclusive. Thus, for example, as shown in FIG. 5, the blade 20 may include three spikes or points 32 projecting outward from the end face 30. Those spikes or points are preferably equidistantly spaced from one another, with the middle spike being located on the central longitudinal axis of the blade. Other multi-spike arrangements are contemplated by this invention, so long as the number of spikes used will not substantially degrade or mar the appearance of the screw's slot by making so many penetrations that such penetrations will be readily visible to the naked eye.

As should be appreciated by those skilled in the art from the foregoing, by adding a small spike at the end of a driver blade the subject invention provides a heretofore unimagined simple, extremely effective, and very reliable resolution to the problem of driving slotted screws having a single slot with a planar bottom surface. In fact, it is believed that this invention provides a means for driving single slotted screws with equal ease and efficiency to that provided by specially designed screws and drivers like those of the prior art described above, particularly when driving screws electrically. However, the subject invention accomplishes that end without the need for screws having special features. Thus, by simply including as small symmetrically tapered sharp spike at the end of the drive blade to penetrate or embed in the material making up at the bottom of the screw slot even slightly, the screwdriver blade of this invention is prevented from sliding longitudinally along the slot, provided that a modicum of force is applied to drive the screw. All of this is accomplished without marring the appearance of the screw, e.g., only a single small depression is left in the screw when using the single spike embodiment or only three small depressions are left in the screw when using the three spike embodiment.

Moreover, the spike of this invention is such that it effectively secures the blade of the screwdriver to whatever material the screw is made of and does so without demanding any additional pressure than is typically applied to driving the screw. It will be recognized however that while advantage is gained with no additionally pressure, certain conditions may exist where still greater advantage and stability can be achieved with a greater pressure. In the case of harder materials, while penetration of the spike will generally be less with a given pressure, being naturally stronger they still achieve greater resistance to sliding even with the shallower interference. Softer, weaker materials on the other hand inversely will generally demand greater interference to prevent slippage but again due to naturally being easier to penetrate conveniently allow greater interference thus offsetting any reduction in stability caused by less strength of the material. Thus while the subject invention has an advantage in all materials, it will additionally offer further advantage in the case of more slippery materials such as plastic. It should also be noted the level of function is now so improved that awkward or difficult access situations are likely easier to manage even where the typically desired pressure isn't possible.

While it is of course preferred to keep the screwdriver blade somewhat centrally located longitudinally within the screw slot, the detrimental affect even with less than optimal centering is minimal since the position of the blade is so stable. This is true as well when driving the screws electrically, where previously a small misalignment would have most often lead to further degradation in position and the ability to drive the screw. Thus, this invention further saves time and improves ease of use by sparing the user from the demand for precision alignment.

Whether a single or multiple spikes are used, they should be relatively short in order to ensure that a high percentage of the driver's blade geometry may still engage the sides of the screw slot. Here a single centrally located spike or point will have an advantage over multiple spikes in allowing the opposing sides of the driver blade to easily rotate about the axis of the spike to bear against their respective sides of the screw's slot. Preferably the spike or spikes are extremely sharp to aid in penetration of the screw material and configured with a taper angle that balances ease of penetration with minimal force and yet still provides sufficient strength to reliably and repeatedly engage harder materials rendering the tool both effective and long lasting. The forming of the spikes should be done in a way that is most efficient or desirable from a manufacturing standpoint.

Since the subject invention makes use of the spike(s) penetrating somewhat into the material making up the screw, the spike(s) may be formed of a different and harder material than the material making up the blade itself to ensure that the spike will penetrate into the bottom of the screw's slot with the application of a normal applied force. Thus, for example if the screw to be driven is particularly hard, the spike(s) may be formed of a very hard material, such as tungsten carbide, titanium, and the like. In such a case the spike(s) or the entire blade can be formed of such very hard material.

In summary, the screw driver blade of this invention provides an improved means for driving slotted head screws by securing the position of blade's tip within the screw's slot, thus mitigating the common and annoying difficulty of keeping the blade properly positioned therein and from slipping out. This improved function is achieved by adding at least one single small spike or point at the end of the screwdriver blade to dig-in or embed into the material making up at the bottom of the screw slot, thereby preventing slippage. Moreover, the use of the spike or point to dig-in or embed into the material of the slot requires no more pressure than is typically applied to drive the screw. Thus, this invention provides a simple, highly functional, cost effective means to easily drive slotted screws heretofore unimagined for this type of screw both manually and electrically and does so without marring the screw.

Without further elaboration the foregoing will so fully illustrate my invention that others may, by applying current or future knowledge, adopt the same for use under various conditions of service.

I claim:

1. A driver blade for driving a slotted screw, said slotted screw comprising a head having a single transversely extending slot with a planar bottom surface, said driver blade comprising an elongated body having a central longitudinal axis and a tip, said tip having a distal end in the form of a planar end face, said end face being arranged to engage the planar bottom surface of the screw slot and including a sharply symmetrically tapered spike projecting outward from said planar end face along an axis parallel to said central longitudinal axis, said spike being arranged to dig into the material of the screw at the planar bottom surface of the slot to prevent slippage of said tip within the slot so that the screw can be driven expeditiously, whereupon after driving of the screw only a single small depression remains in the bottom of the screw's slot, thereby not marring the appearance of the slot.

2. The driver blade of claim 1 wherein said spike is conical.

3. The driver blade of claim 1 wherein said spike is pyramidal.

4. The driver blade of claim 1 wherein said tip is formed of a first material and wherein said spike is formed of said first material.

5. The driver blade of claim 1 wherein said tip is formed of a first material and wherein said spike is formed of a second material, said second material being harder than said first material.

6. The driver blade of claim 1 wherein said axis of said spike is coaxial with said central longitudinal axis.

7. The driver blade of claim 1 wherein said blade comprises three spikes projecting outward from said end face, one of said spikes being located on said central longitudinal axis and the other two of said spikes being equidistantly spaced from said spike on said central longitudinal axis.

8. The driver blade of claim 7 wherein each of said spikes is conical.

9. The driver blade of claim 7 wherein each of said spikes is pyramidal.

10. The driver blade of claim 1 wherein said blade is secured to a handle to form a screwdriver.

11. The driver blade of claim 1 wherein said blade is arranged to be disposed within a socket or chuck.

12. A method of driving a conventional slotted screw, the screw including a head having a single transversely extending slot which is not undercut, the slot having a bottom surface which is planar, said method comprising:
(a) providing a screwdriver blade comprising an elongated body having a central longitudinal axis and a tip, said tip having a distal end in the form of a planar end face, said planar end face being arranged to engage the planar bottom surface of the screw's slot, said tip also including a sharply symmetrically tapered spike projecting outward from said planar end face along an axis parallel to the central longitudinal axis;
(b) inserting said blade into the screw's slot; and
(c) applying a force on said blade in a direction along said central longitudinal axis to drive said screw, whereupon said spike engages and penetrates into the material at the bottom surface of the screw's slot and said planar end face of said blade engages that bottom surface to drive the screw expeditiously without said blade slipping in the screw's slot, whereupon after driving of the screw only a single small depression remains in the bottom of the screw's slot, thereby not marring the appearance of said slot.

13. The method of claim 12 wherein said spike is conical.

14. The method of claim 12 wherein said spike is pyramidal.

15. The method of claim 12 wherein said tip is formed of a first material and wherein said spike is formed of said first material.

16. The method of claim 12 wherein said tip is formed of a first material and wherein said spike is formed of a second material, said second material being harder than said first material.

17. The method of claim 12 wherein said axis of said spike is coaxial with said central longitudinal axis.

18. The method of claim 12 wherein said blade comprises three spikes projecting outward from said end face, one of said spikes being located on said central longitudinal axis and the other two of said spikes being equidistantly spaced from said spike on said central longitudinal axis, whereupon after driving of the screw only three small depressions remain in the bottom of the screw's slot, thereby not marring the appearance of said slot.

19. The method of claim 18 wherein each of said spikes is conical.

20. The method of claim 18 wherein each of said spikes is pyramidal.
